(19) United States
(12) Patent Application Publication
(10) Pub. No.: US 2008/0309707 A1
(43) Pub. Date: Dec. 18, 2008

(54) CARRIAGE CONTROL DEVICE, LIQUID EJECTING APPARATUS, AND CARRIAGE CONTROL PROGRAM

(75) Inventor: Kazuhiko ARIMORI, Kitakyushu-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 12/139,316

(22) Filed: Jun. 13, 2008

(30) Foreign Application Priority Data
Jun. 15, 2007 (JP) 2007-158564

(51) Int. Cl. B41J 23/00

(52) U.S. Cl. 347/39

(57) ABSTRACT

There is provided a carriage control device for executing a reciprocal movement control of a carriage in a liquid ejecting apparatus including the carriage that is supported so as to be able to be reciprocally moved in a predetermined direction, the carriage mounting a liquid ejecting head that ejects liquid on a material to be ejected, and a liquid supply tube having thermoplastic property for supplying liquid from a liquid storage unit to the carriage, the liquid supply tube being elastically deformed by following a reciprocal movement of the carriage. A dynamic load of the carriage is measured at a predetermined timing, and a control for repeating a reciprocal operation of the carriage without ejecting liquid from the liquid ejecting head by a predetermined number of times is executed based on the measured dynamic load.

### BACKGROUND

1. Technical Field

The present invention relates to a reciprocal movement control of a carriage of a liquid ejecting apparatus in which the carriage mounting a liquid ejecting head for ejecting liquid on a material to be ejected is supported so as to be able to be reciprocally moved in a predetermined direction and in which a liquid supply tube that supplies liquid from a liquid storage unit to the carriage has thermoplastic property and is elastically deformed by following the reciprocal operation of the carriage.

2. Related Art

As for an example of a liquid ejecting apparatus in which a carriage mounting a liquid ejecting head for ejecting liquid on a material to be ejected is supported so as to be able to be reciprocally moved in a predetermined direction and in which liquid is ejected from the liquid ejecting head on a material to be ejected while reciprocally moving the carriage, so called an ink jet printer is known (for example, see JP-A-2006-255899). In such an ink jet printer, an ink jet printer of an off carriage type is known in which an ink tube capable of flexible elastic deformation by following reciprocal movement of the carriage is provided in a bent posture of a U character shape and ink is supplied to the carriage from an ink cartridge or the like provided in a printer main body (for example, see JP-A-2006-231837) besides an ink jet printer of an on carriage type in which the ink cartridge in which ink is filled is mounted on the carriage.

The ink tube used for the ink jet type printer of an off carriage type or the like is necessary to follow reciprocal movement of the carriage to be able to be flexibly elastically deformed. Generally, the ink tube is formed by a generalized plastic having thermoplastic property such as polyethylene, polypropylene, polystyrene, or the like, or the like. Generally, when a material having thermoplastic property is heated, the whole of the material is softened to have flow property that enables formation, and when cooled down after the formation, the material loses flow property to be hardened. Further, when heated again, the material is softened again, and when cooled down, the material is hardened again. That is, softening and hardening are reversible reaction.

For this reason, in the ink jet printer of an off carriage type or the like, when the printer is left under an environment of a high temperature, for example, in the vicinity of about 60 degrees for a long period, the ink tube is softened in some degree than in the normal temperature in the state where bent in a U character shape although the ink tube does not have flow property that enables formation. Then when the temperature is returned to the normal temperature, the ink tube is hardened in the state where bend in a U character shape. That is, bending tendency of a bent shape is occurred in the ink tube.

Herewith, a phenomenon occurs in which a dynamic load when reciprocally moving the carriage is increased and a difference of dynamic loads in the following direction and the backward direction is increased. Accordingly, in the ink jet printer of an off carriage type or the like, when returned to the normal temperature after the printer is left under an environment of a high temperature for a long period, there is a fear in that accuracy of reciprocal operation of the carriage is deteriorated and ejection accuracy of ink is deteriorated.

### SUMMARY

An advantage of some aspects of the invention is to prevent deterioration of ejection accuracy of liquid when returned to the normal temperature after leaving under an environment of a high temperature for a long period in a liquid ejecting apparatus in which a liquid supply tube that supplies liquid from a liquid storage unit to a carriage has thermoplastic property and is elastically deformed by following reciprocal movement of the carriage.

According to a first aspect of the invention, there is provided a carriage control device for executing a reciprocal movement control of a carriage in a liquid ejecting apparatus including the carriage that is supported so as to be able to be reciprocally moved in a predetermined direction, the carriage mounting a liquid ejecting head that ejects liquid on a material to be ejected, and a liquid supply tube having thermoplastic property for supplying liquid from a liquid storage unit to the carriage, the liquid supply tube being elastically deformed by following a reciprocal movement of the carriage. A dynamic load of the carriage is measured at a predetermined timing, and a control for repeating a reciprocal operation of the carriage without ejecting liquid from the liquid ejecting head by a predetermined number of times is executed based on the measured dynamic load.

As described above the liquid supply tube having thermoplastic property becomes a state where bending tendency of a bent shape is occurred when the liquid ejecting apparatus is left under an environment of a high temperature and thereafter returned to the normal temperature. Herewith, a phenomenon occurs in the liquid ejecting apparatus in which the dynamic load when reciprocally moving the carriage is increased and a difference of the dynamic loads in a forward direction and a backward direction becomes larger. That is, when the dynamic load of the carriage is measured, whether bending tendency of a bent shape is occurred in the liquid supply tube by leaving under an environment of a high temperature or the like and thereafter returning to the normal temperature or the like or not can be specified based on the measured dynamic load.

Then, the state in which the bending tendency of a bent shape is occurred is absolutely a superficial phenomenon, and the shape of the liquid supply tube is not fundamentally deformed. Accordingly the bending tendency of a bent shape can be corrected by repeating bending and extending of the liquid supply tube performed by the reciprocal operation of the carriage without ejecting liquid by a predetermined number of times. To be more specific, by repeating bending and extending of a portion in which bending tendency of a bent shape is occurred by a predetermined number of times, it is considered that the surface texture of the portion of the liquid supply tube hardened in a bent state is unstiffened to be softened so as to be broken, thereby the bending tendency of a bent shape can be corrected.

Herewith, in the carriage control device according to the first aspect of the invention, in the liquid ejecting apparatus in which the liquid supply tube having thermoplastic property for supplying liquid from the liquid storage unit to the carriage is elastically deformed by following the reciprocal movement of the carriage, the bending tendency of a bent shape occurred in the liquid supply tube can be corrected by leaving the liquid ejecting apparatus under an environment of a high temperature for a long period or the like and thereafter returning to the normal temperature. Accordingly, an effect that it can be prevented that ejection accuracy of liquid is deteriorated when leaving the liquid ejecting apparatus under an environment of a high temperature for a long period or the like and thereafter returning to the normal temperature can be obtained.

According to a second aspect of the invention, there is provided a carriage control device in which when the measured dynamic load is larger than a threshold, the control for repeating a reciprocal operation of the carriage without ejecting liquid from the liquid ejecting head by a predetermined number of times is executed in the carriage control device according to the first aspect.

As described above, when the liquid ejecting apparatus is left under an environment of a high temperature for a long period or the like and thereafter returned to the normal temperature, the bending tendency of a bent shape is occurred in the liquid supply tube. This causes a phenomenon in which the dynamic load when reciprocally moving the carriage is increased. Accordingly, whether bending tendency of a bent shape is occurred in the liquid supply tube by leaving under an environment of a high temperature or the like and thereafter returning to the normal temperature or the like or not can be specified by whether the dynamic load measured at a predetermined timing is larger than a constant threshold or not.

According to a third aspect of the invention, there is provided a carriage control device in which when a difference between the measured dynamic load in a forward direction and the measured dynamic load in a backward direction is lager than a threshold, the control for repeating a reciprocal operation of the carriage without ejecting liquid from the liquid ejecting head by a predetermined number of times is executed in the carriage control device according to the first or second aspect.

As described above, when the liquid ejecting apparatus is left under an environment of a high temperature for a long period or the like and thereafter returned to the normal temperature, the bending tendency of a bent shape is occurred in the liquid supply tube. This causes a phenomenon in which a difference between the dynamic loads when the carriage is reciprocally moved in the forward direction and the backward direction becomes large. Accordingly, whether bending tendency of a bent shape is occurred in the liquid supply tube by leaving under an environment of a high temperature or the like and thereafter returning to the normal temperature or the like or not can be specified by whether the difference between the dynamic load in the forward direction and the dynamic load in the backward direction measured at a predetermined timing is larger than a constant threshold or not.

According to a fourth aspect of the invention, there is provided a carriage control device in which a dynamic load of the carriage is measured again after the control for repeating a reciprocal operation of the carriage without ejecting liquid from the liquid ejecting head by a predetermined number of times is executed in the carriage control device according to any one of the first to third aspects.

It can be confirmed that the bending tendency of a bent shape occurred in the liquid supply tube is corrected or not by the reciprocal operation of the carriage by measuring the dynamic load of the carriage again after repeating extending and bending of the liquid supply tube performed by the reciprocal operation of the carriage without ejecting liquid for a predetermined number of times in order to correct the bending tendency of a bent shape occurred in the liquid supply tube. Then, when the bending tendency of a bent shape occurred in the liquid supply tube is not fully corrected, the extending and bending of the liquid supply tube performed by the reciprocal operation of the carriage without ejecting liquid can be executed again. Accordingly, in the carriage control device according to the fourth aspect of the invention, an effect can be obtained in which the bending tendency of a bent shape occurred in the liquid supply tube can be more surely corrected.

According to a fifth aspect of the invention, there is provided a carriage control device in which a timing right after a power source of the liquid ejecting apparatus is turned on is included in the predetermined timing in the carriage control device according to any one of the first to fourth aspects.

In this manner, by measuring the dynamic load of the carriage right after the power source of the liquid ejecting apparatus is tuned on, it can be detected that whether, for example, the liquid ejecting apparatus is left under an environment of a high temperature for a long period or the like in the sate where the power source is off can be detected after the power source of the liquid ejecting apparatus is turned on and before executing liquid ejection. Accordingly, when the liquid ejecting apparatus is left for a long period or the like in the sate where the power source is off, it can be prevented to execute liquid ejection on a material to be ejected in the state where the ejection accuracy of liquid is deteriorated. Further, by measuring the dynamic load of the carriage right after the power source is turned on, the measurement of the dynamic load for an initial setting for controlling the carriage can be performed at the same time. Accordingly, there is almost no influence to the time required for the initial setting when the power source of the liquid ejecting apparatus is turned on.

According to a sixth aspect of the invention, there is provided a carriage control device in which a timing when not less than a predetermined period is passed in the state where no reciprocal operation of the carriage is executed is included in the predetermined timing in the carriage control device according to any one of the first to fifth aspects.

In this manner, by measuring the dynamic load of the carriage when a predetermined period is passed in the state where no reciprocal operation of the carriage is executed, when, for example, the liquid ejecting apparatus is left for a long period in the state where the power source is on, it can be detected that whether the liquid ejecting apparatus is left under an environment of a high degree or the like during the period or not. Accordingly, when the liquid ejecting apparatus is left for a long period or the like in the state where the power source is on, it can be prevented to execute liquid ejection on a material to be ejected in the state where the ejection accuracy of ink is deteriorated.

According to a seventh aspect of the invention, there is provided a liquid ejecting apparatus including a carriage that is supported so as to be able to be reciprocally moved in a predetermined direction, the carriage mounting a liquid ejecting head that ejects liquid on a material to be ejected and a liquid supply tube having thermoplastic property for supplying liquid from a liquid storage unit to the carriage, the liquid supply tube being elastically deformed by following a reciprocal movement of the carriage. The liquid ejecting apparatus includes the carriage control device according to any one of the first to sixth aspects.

In the liquid ejecting apparatus according to the seventh aspect of the invention, the effect according to any one of the first to sixth aspects of the invention can be obtained in the liquid ejecting apparatus including a carriage that is supported so as to be able to be reciprocally moved in a predetermined direction, the carriage mounting a liquid ejecting head that ejects liquid on a material to be ejected and a liquid supply tube having thermoplastic property for supplying liquid from a liquid storage unit to the carriage, the liquid supply tube being elastically deformed by following a reciprocal movement of the carriage.

According to an eighth aspect of the invention, there is provided a liquid ejecting apparatus that includes a carriage detecting unit capable of detecting a moving amount of the carriage, and a carriage driving unit for reciprocally moving the carriage, and in which the carriage control device controls the carriage driving unit based on a detection signal output from the carriage detecting unit in the liquid ejecting apparatus according to the seventh aspect.

In the liquid ejecting apparatus equipped with the carriage detecting unit capable of detecting a moving amount of the carriage, the dynamic load when the carriage is reciprocally moved can be specified from a moving amount and a moving speed of the carriage with respect to a control amount of the carriage driving unit when reciprocally moving the carriage.

According to a ninth aspect of the invention, there is provided a carriage control program that causes a computer to execute a reciprocal movement control of a carriage in a liquid ejecting apparatus including the carriage that is supported so as to be able to be reciprocally moved in a predetermined direction, the carriage mounting a liquid ejecting head that ejects liquid on a material to be ejected, and a liquid supply tube having thermoplastic property for supplying liquid from a liquid storage unit to the carriage, the liquid supply tube being elastically deformed by following a reciprocal movement of the carriage. The reciprocal movement control includes measuring a dynamic load of the carriage at a predetermined timing, and repeating a reciprocal operation of the carriage without ejecting liquid from the liquid ejecting head by a predetermined number of times based on the measured dynamic load.

In the carriage control program according to the ninth embodiment of the invention, the effect similar to that of the first aspect can be obtained. Further, the effect similar to that of the first aspect can be obtained for any liquid ejecting apparatus capable of executing the carriage control program.

### BRIEF DESCRIPTION OF THE DRAWINGS

The invention will be described with reference to the accompanying drawings, wherein like numbers reference like elements.

FIG. 1 is a plan view showing a main portion of an ink jet printer.

FIG. 2 is a cross sectional view showing a main portion the ink jet printer.

FIG. 3 is a block diagram showing an outline of the ink jet printer.

FIG. 4 is a block diagram schematically illustrating a driving mechanism of a carriage.

FIG. 5 is a plan view schematically illustrating reciprocal operation of the carriage in a main scanning direction.

FIG. 6 is a flow chart illustrating a first embodiment of a carriage control procedure.

FIG. 7 is a flow chart illustrating a second embodiment of the carriage control procedure.

FIG. 8 is a flow chart illustrating a third embodiment of the carriage control procedure.

### DESCRIPTION OF EXEMPLARY EMBODIMENTS

Hereinafter, embodiments of the invention will be described with reference to the accompanying drawings.

First, a schematic structure of an ink jet printer as an example of the “liquid ejecting apparatus” according to the invention will be described.

### Schematic Structure of Ink Jet Printer

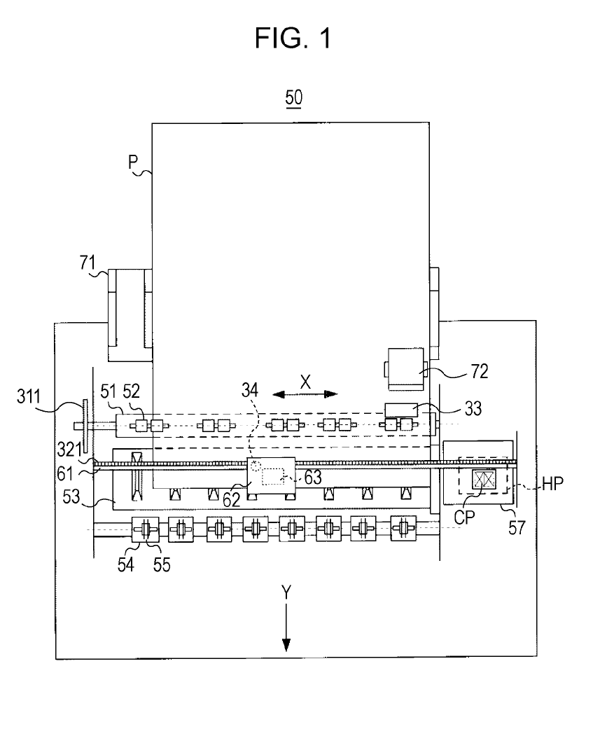

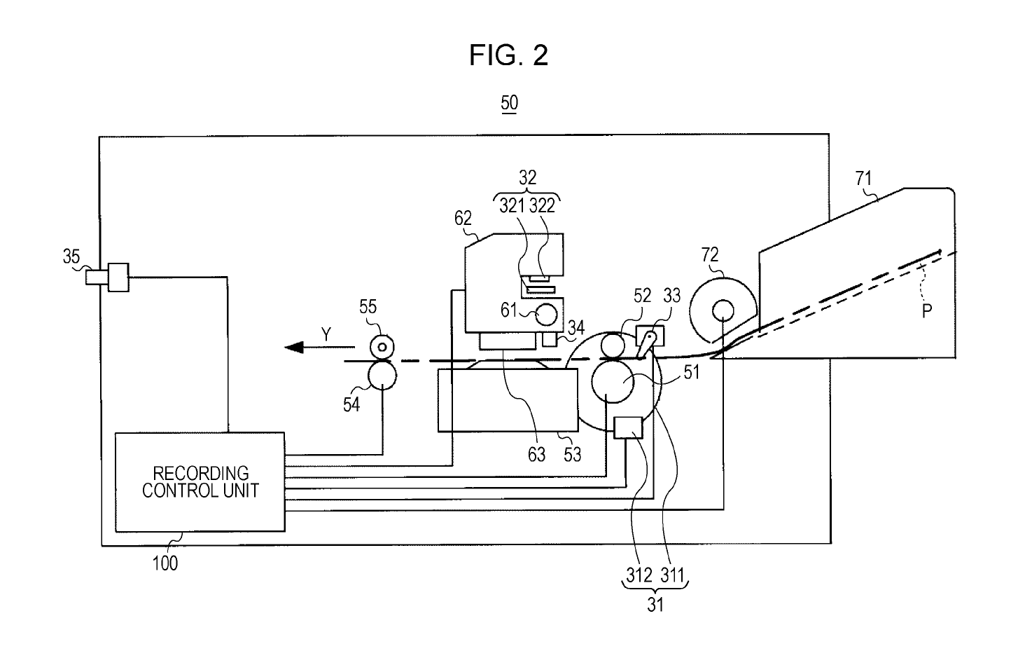

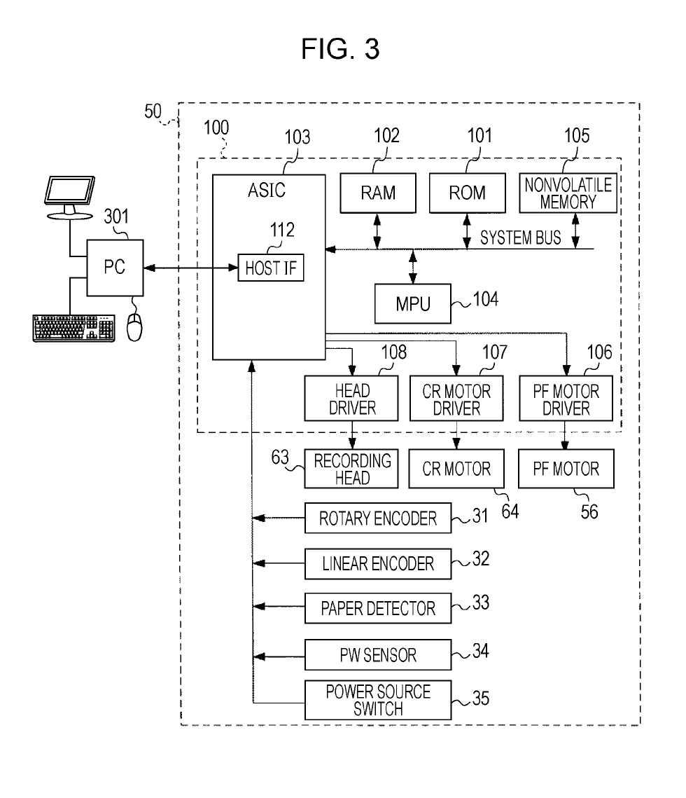

FIG. 1 is a plan view showing a main portion of an ink jet printer 50, and FIG. 2 is a side view thereof. FIG. 3 is a block diagram showing an outline the ink jet printer 50.

The ink jet printer 50 is equipped with a feed tray 71 and a feed roller 72 as auto feed means of a recording paper P as the “material to be ejected”. The recording papers P laminated on the feed tray 71 are automatically fed in the ink jet printer 50 one by one by the driving rotation of the feed roller 72. At this time, it is prevented that a plurality of recording papers P are fed at the same time in an overlapped state by known separating means such as a separating pad or the like not shown.

A transport driving roller 51 and a plurality of transport driven rollers 52 on which films having a high friction resistance are provided on the outer circumferential surfaces are provided at a downstream side of the feed roller 72 in a sub canning direction as means for transporting the recording paper P in a sub scanning direction Y. Rotation driving force of a PF motor (FIG. 3) is transmitted by gears to rotate the transport driving roller 51. The transport driven rollers 52 are pivotally supported so as to be able to be driven to rotate and are biased so as to be made contact with the outer circumferential surface of the transport driven roller 51. A known paper detector 33 capable of detecting the front end and back end of the recording paper P is disposed between the feed roller 72 and the transport driving roller 51 the recording paper P automatically fed by the driving rotation of the feed roller 72 is transported in the sub scanning direction Y by the driving rotation of the transport driving roller 51 in the state where pinched between the transport driving roller 51 and the transport driven rollers 52.

A known rotary encoder 31 for detecting a rotation state of the transport driving roller 51 is provided in the ink jet printer 50. The rotary encoder 31 includes a rotary scale 311 that rotates in conjunction with the rotation of the transport driving roller 51, and a rotary scale sensor 312 for detecting slits formed along the outer circumference of the rotary scale 311 at even intervals. A pulse signal having a cycle proportional to the rotation speed of the transport driving roller 51 is output from the rotary encoder 31.

A platen 53 for supporting the recording paper P from the back surface side is provided at the downstream side of the transport driving roller 51 in the sub scanning direction Y. A carriage 62 pivotally supported by a carriage guide axis 61 so as to be able to be reciprocally moved in a main scanning direction X is provided above the platen 53. A recording head 63 as the “liquid ejecting head” for ejecting ink as the “liquid” on the recording paper P and a PW sensor 34 constituted by an optical type sensor or the like capable of detecting the recording paper P on the platen 53 without making contact therewith are provided at the bottom of the carriage 62.

Rotation driving force of a CR motor 64 (FIG. 3) is transmitted to the carriage 62 by an endless belt of a belt transmission mechanism not shown, and the carriage 62 is reciprocally moved in the main scanning direction X. A known linear encoder 32 as the “carriage detecting unit” capable of detecting a moving amount of the carriage 62 includes a linear scale 321 disposed in the vicinity of the carriage 62 in approximately parallel to the main scanning direction X of and a linear scale sensor 322 that detects slits formed on the linear scale 321 mounted on the carriage 62 at even intervals (FIG. 2).

A known capping device 57 is provided at the outer side of an end side of a reciprocal movement area of the carriage 62 in the main scanning direction X. In the standby state in which no recording is performed, the carriage 62 is moved on the capping device 57 and is stopped, and the head surface of the recording head 63 is enclosed by a cap CP provided in the capping device 57. The stop position of the carriage 62 is defined as a home position HP. A discharge driving roller 54 and discharge driven rollers 55 for discharging the recording paper P on which recording is performed are provided at the downstream side of the platen 53 in the sub scanning direction Y. The discharge driven rollers 55 are pivotally supported so as to be able to be driven to rotate and biased so as to be made contact with the outer circumferential surface of the discharge driving roller 54. The recording paper P on which recording is performed is discharged by the driving rotation of the discharge driving roller 54 in the state where the paper P is pinched by the discharge driving roller 54 and the discharge driven rollers 55.

In the ink jet printer 50 having the structure, the operation for transporting the recording paper P in the sub scanning direction Y by the driving rotation of the transport driving roller 51 by a predetermined transport amount and the operation for reciprocally moving the carriage 62 in the main scanning direction X while ejecting ink on the recording paper P from the head surface of the recording head 63 are alternately repeated, thereby dots are formed on the recording surface of the recording paper P to perform recording, and the recording paper P is discharged by the driving rotation of the discharge driving roller 54. A PF motor 56 (FIG. 3) for rotatably driving the feed roller 72, the transport driving roller 51, and the discharge driving roller 54, and a CR motor 64 (FIG. 3) for driving the carriage 62 in the main scanning direction are controlled by a recording control unit 100. Further, the recording head 63 is also controlled by the recording control unit 100.

### Schematic Structure of Recording Control Unit 100

Subsequently, a schematic structure of the recording control unit 100 will be described with reference to FIGS. 1 to 3.

A ROM 101, a RAM 102, an ASIC 103, an MPU 104, and a nonvolatile memory 105 are connected to a system bus of the recording control unit 100. Output signals of the rotary encoder 31, the linear encoder 32, the paper detector 33, the PW sensor 34, and a power source switch 35 for turning the power source of the ink jet printer 50 ON/OFF are input to the MPU 104 via the ASIC 103. The MPU 104 performs an arithmetic processing for executing recording control of the ink jet printer 50 and other necessary arithmetic processing based on the output signals of the paper detector 33 and the PW sensor 34 or the like. A recording control program (firmware) and the like necessary for controlling the ink jet printer 50 by the MPU 104 are stored in the ROM 101, and various data and the like necessary for processing the recording control program are stored in the nonvolatile memory 105. The RAM 102 is used as an operation area of the MPU 104 and a temporal storage area of recording data.

The ASIC 103 includes a control circuit for performing rotation control of the PF motor 56 and the CR motor 64 which are DC motors and drive control of the recording head 63. The ASIC 103 performs various calculations for performing the rotation control of the PF motor 56 and the CR motor 64 based on a control instruction sent from the MPU 104, an output signal from the rotary encoder 31, and an output signal from the linear encoder 32, and sends motor control signals based on the calculated results to a PF motor driver 106 and a CR motor driver 107. Further, the ASIC 103 calculates and generates a control signal for the recording head 63 based on the recording data send from the MPU 104 or the like, and sends the control signal to a head driver 108 to drive and control the recording head 63. The ASIC 103 includes a host IF 112 for providing information transmission with a personal computer 301 or the like as an “information processing device”.

### Driving Mechanism of Carriage

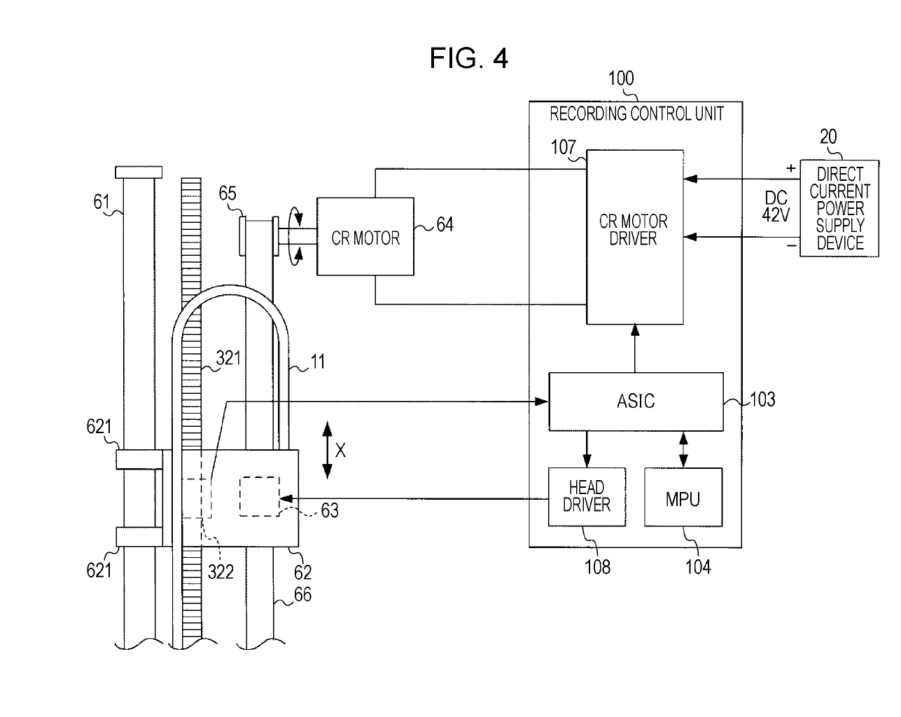

Subsequently, a driving mechanism as a “carriage driving unit” for reciprocally moving the carriage 62 will be described with reference to FIG. 4.

FIG. 4 is a block diagram schematically illustrating the driving mechanism of the carriage 62.

The carriage 62 is pivotally supported by a carriage guide axis 61 at bearing portions 621. An endless belt 66 is wound around between a driving pulley 65 provided at a rotation axis of the CR motor 64 and a driven pulley not shown. A part of the endless belt 66 is coupled to the carriage 62, and the rotation driving force of the CR motor 64 in the both directions is transmitted to the carriage 62 via the endless belt 64 to reciprocate the carriage 62 in the main scanning direction X.

An output voltage of a direct current constant voltage power supply device 20 is applied to the CR motor 64 via the CR motor driver 107. The CR motor driver 107 executes PWM control for adjusting the electric power supplied to the CR motor 64 by applying pulses having a constant voltage and a constant cycle (PWM basic cycle) generated from the output voltage of the direct current constant voltage power supply device 20 and by adjusting ON time of the pulses (control duty). The recording control unit 100 as the “carriage control device” that executes reciprocal moving control of the carriage 62 calculates a moving amount and a moving speed of the carriage 62 from an output signal of the linear scale sensor 322 of the linear encoder 32 by the MPU 104 and outputs a control signal of the CR motor 64 which is the driving power source of the carriage 62 to the CR motor driver 107 based on the moving amount and the moving speed of the carriage 62.

Inks of each color ejected from the recording head 63 are separately stored in an ink cartridge (not shown) as the “liquid storage unit” provided in the main body of the ink jet printer 50 in a removable manner. The inks of each color in the ink carriage are supplied to the carriage 62 via an ink tube 11 as the “liquid supply tube” and ejected from the recording head 63. That is, the ink jet printer 50 is so called an ink jet printer of an off carriage type. The ink tube 11 provided in a bent state of a U character shape as shown in FIG. 4 is equipped with supply pathways of inks of each color and is formed by an elastic material having thermoplastic property. The ink tube 11 follows the reciprocal movement of the carriage in the main scanning direction X to be elastically deformed.

Note that as for the material having thermoplastic property, there are included a generalized plastic or the like, for example, such as polyethylene, polypropylene, polystyrene, or the like. Further, as for the material having thermoplastic property having flexibility and durability suited for the ink tube 11 of the ink jet printer 50, for example, Bridgestone MNCS or the like is included.

### Aging Control of Ink Tube

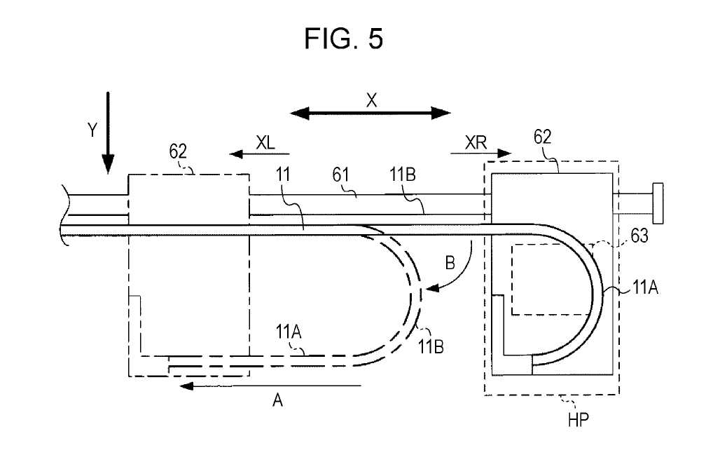

Subsequently, an aging control of the ink tube 11 performed by the recording control unit 100 as the “carriage control device” according to the invention will be described with reference to FIG. 5.

FIG. 5 is a plan view schematically showing reciprocal operation of the carriage 62 in the main scanning direction X.

The ink tube 11 formed by an elastic material having thermoplastic property is connected to an ink cartridge not shown at one end side and provided by a route approximately parallel to the main scanning direction X as show in FIG. 5, and is connected to the carriage 62 at the other end side in the state where the ink tube 11 is bent in a U character shape in mid-course. The ink tube 11 follows reciprocal movement of the carriage 62 in the main scanning direction X and elastically deformed so that the bent position of the U character shape is transited.

When the carriage 62 is moved in a forward direction XL from the home position HP, a portion 11A of the ink tube 11 bent and deformed in a U character shape becomes an extended state in a straight line manner as shown by symbol A and a portion 11B of the ink tube 11 extended in a straight line manner becomes a bent and deformed state in a U character shape as shown by symbol B. That is, at the portion 11A, a force acts to the carriage 62 in the direction to reduce the dynamic load by elastic restoring force for returning the ink tube 11 bent and deformed in a U character shape in a straight line manner. On the contrary, at the portion 11B, a force acts in the direction to increase the dynamic load by the ink tube 11 extended in a straight line manner that is bent and deformed in a U character shape against elastic force.

On the other hand, when the carriage 62 is moved in a backward direction XR toward the home position HP, the portion 11A of the ink tube 11 extended in a straight manner becomes a bent and deformed state in a U character shape, and the portion 11B of the ink tube 11 bent and deformed in a U character shape becomes an extended state in a straight line manner. That is, at the portion 11A, a force acts to the carriage 62 in the direction to increase the dynamic load by the ink tube 11 extended in a straight line manner that is bent and deformed in a U character shape against elastic force. On the contrary, at the portion 11B, a force acts in the direction to reduce the dynamic load by elastic restoring force for returning the ink tube 11 bent and deformed in a U character shape in a straight line manner.

In this manner, when the carriage 62 is moved in the forward direction XL and is moved in the backward direction XR, a force for increasing the dynamic load and a force for reducing the dynamic load are acted from the ink tube 11 to the carriage 62 so as to be approximately canceled. Accordingly, the dynamic load of the carriage 62 becomes an approximately constant value regardless of the position of the carriage 62 in the range of reciprocal movement. Further, the carriage 62 reciprocates in the state where a portion of the ink tube 11 is always bent in a U character shape, so that a force for moving the carriage 62 in the backward direction XR is always acted by the elastic restoring force of the ink tube 11. Accordingly, the dynamic load of the carriage 62 when moving in the backward direction XR becomes relatively smaller than when moving in the forward direction XL, and the difference becomes an approximately constant value.

However, when the ink jet printer 50 is left under an environment of a high temperature, for example, in the vicinity of 60 degrees at room temperature for a long period or the like, the ink tube 11 is not softened to have flow property capable of formation, but the ink tube 11 is softened to some extent than in a normal temperature in the state where the portion 11A is bent and deformed in a U character shape as shown in FIG. 5 in the state where the carriage 62 is stopped in the home position HP. Then, when the temperature is returned to a normal temperature, the ink tube 11 is hardened in the state where the portion 11A is bent and deformed in a U character shape. That is, bending tendency of a bent shape is occurred at the portion 11A of the ink tube 11. Herewith, a change describe below occurs in the dynamic load when reciprocally moving the carriage 62 in the main scanning direction X.

First, when the carriage 62 is moved in the forward direction XL from the home position HP, at the portion 11A, a force is acted to the carriage 62 in the direction to increase the dynamic load by the ink tube 11 having bending tendency of a U character bent shape that is deformed in a straight line manner against the elastic force. Further, at the portion 11B, a force is acted also in the direction to increase the dynamic load by the ink tube 11 extended in a straight line manner that is bent and deformed in a U character shape against the elastic force. That is, forces are acted to the carriage 62 in the direction to increase the dynamic load at both the portion 11A and the portion 11B of the ink tube 11. Accordingly, the dynamic load when moving the carriage 62 in the forward direction XL is increased than the normal case.

On the other hand, when the carriage 62 is moved in the backward direction XR toward the home position HP, at the portion 11A, a force is acted to the carriage 62 in the direction to reduce the dynamic load by the elastic restoring force for returning the ink tube 11 extended in a straight line manner to the state where bending tendency of a U character bent shape is occurred. Further, at the portion 11B, a force is acted also in the direction to reduce the dynamic load by the elastic returning force for retuning the ink tube 11 bent and deformed in a U character shape to a straight line manner. That is, forces are acted in the direction to reduce the dynamic load of the carriage 62 at both the portion 11A and the portion 11B of the ink tube 11. Accordingly the dynamic load when moving the carriage 62 in the backward direction XR is reduced than the normal case.

That is, when bending tendency of a bent shape is occurred to the ink tube 11 by leaving the ink jet printer 50 under an environment of a high temperature for a long period or the like, the dynamic load in the case of moving the carriage 62 in the forward direction XL is increased and the dynamic load in the case of moving the carriage 62 in the backward direction XR is reduced. Accordingly, the maximum dynamic load when moving the carriage 62 in the main scanning direction X is increased than the normal case, and the difference between the dynamic load in the forward direction XL and the dynamic load in the backward direction XR is increased than the normal case.

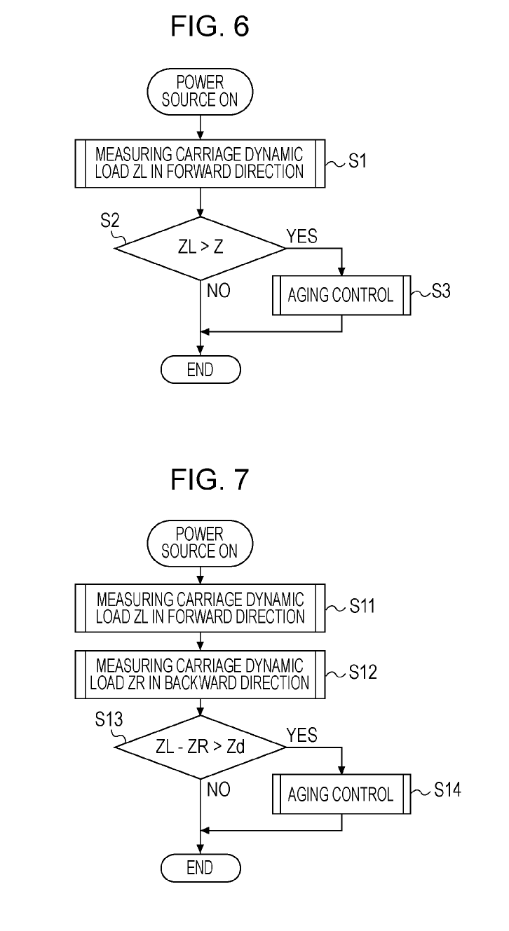

Hereinafter, a procedure for detecting the bending tendency of the ink tube 11 from the change of the dynamic load and an aging control procedure for correcting the bending tendency will be described with reference to FIGS. 6 to 8.

### First Embodiment of Carriage Control Procedure

FIG. 6 is a flow chart illustrating a first embodiment of a carriage control procedure according to the invention.

First, the carriage 62 positioned at the home position HP is moved in the forward direction XL at the time when the power source of the ink jet printer 50 is turned on, and a dynamic load ZL in the forward direction XL is measured (step S1). The dynamic load of the carriage 62 can be specified from the relation of a moving amount and a moving speed of the carriage 62 calculated from an output signal of the linear encoder 32 with respect to a control amount (control duty or the like) of the CR motor 64 controlled by the CR motor driver 107.

Then, whether the dynamic load ZL in the forward direction XL is larger than a preliminarily set threshold Z of the dynamic load or not is judged (step S2). As described above, by leaving the ink jet printer 50 under an environment of a high temperature for a long period or the like, when the ink tube 11 becomes a state where bending tendency of a bent shape is occurred, the dynamic load ZL when moving the carriage 62 in the forward direction XL is increased. Accordingly, whether bending tendency of a bent shape is occurred in the ink tube 11 or not can be judged by whether the dynamic load ZL in the forward direction XL is larger or not than the preliminarily set threshold Z of the dynamic load.

Note that the threshold Z can be set to an appropriate value from the relation with the dynamic load in the normal case, for example, by performing an experiment or the like for empirically recreating a state in which bending tendency of a bent state is occurred in the ink tube 11 by leaving the ink jet printer 50 under an environment of a high temperature for a long period or the like and for measuring the dynamic load in the forward direction XL at the case.

When the dynamic load ZL in the forward direction XL is not less than the preliminarily set threshold Z of the dynamic load (No in step S2), it is judged that no bending tendency of a bent shape is occurred in the ink tube 11 by leaving under an environment of a high temperature for a long period or the like, and the procedure is finished without change. Then, when the dynamic load ZL in the forward direction XL is larger than the preliminarily set threshold Z of the dynamic load (Yes in step S2), it is judged that bending tendency of a bent shape is occurred in the ink tube 11 by leaving under an environment of a high temperature for a long period or the like, and a predetermined aging control is executed (step S3), and thereafter the procedure is finished.

Herein, the predetermined aging control (step S3) means a control for repeating a reciprocal operation of the carriage 62 without ejecting ink from the recording head 63 by a predetermined number of times. As described above, the bending tendency of a bent shape of the ink tube 11 occurred by leaving the ink tube 11 under an environment of a high temperature for a long period in a bent state or the like is absolutely a superficial phenomenon, and the shape of the ink tube 11 is not fundamentally deformed. Accordingly the bending tendency of a bent shape can be corrected by repeating bending and extending of the ink tube 11 performed by the reciprocal operation of the carriage 62 without ejecting ink by a predetermined number of times.

Note that an appropriate number of times for executing the reciprocal operation of the carriage 62 without ejecting ink from the recording head 63 can be determined from an experiment or the like, for example, for recreating a state where bending tendency of a bent state is occurred in the ink tube 11 by leaving the ink jet printer 50 under an environment of a high temperature for a long period or the like and for measuring the dynamic load while reciprocally moving the carriage 62. The appropriate number of times of the reciprocal operation is different depending on the material, shape, of the ink tube 11 or the like. However, the bending tendency can be approximately corrected by, for example, the reciprocal movement of about 20 to 30 times.

In this manner, according to the invention, the deterioration of the ejection accuracy of ink can be prevented when returned to the normal temperature after leaving the ink jet printer 50 under an environment of a high temperature for a long period or the like.

Further, by measuring the dynamic load of the carriage 62 right after switching on the power source of the ink jet printer 50, for example, whether the ink jet printer 50 is left under an environment of a high temperature for a long period in the state where the power source is off or not can be detected after the power source of the ink jet printer 50 is turned on and before using the ink jet printer 50. Accordingly, it can be prevented to execute ink ejection on the recording paper P in the state where the ejection accuracy of ink is deteriorated when using the ink jet printer 50 after the ink jet printer 50 is left for a long period in the state where the power source is off. Further, by measuring the dynamic load of the carriage 62 right after the power source is turned on, the measurement of the dynamic load for an initial setting necessary for controlling the carriage 62 can be performed at the same time, so that a time required for an initial setting when the power source is turned on is virtually not increased.

In addition, the timing for measuring the dynamic load ZL in the forward direction XL is not particularly limited to the time when the power source of the ink jet printer 50 is turned on, and any timing may be allowable in the embodiment of the invention. For example, the timing may be a timing when a predetermined period is passed in the state where no reciprocal operation of the carriage 62 is executed in the state where the power source of the ink jet printer 50 is on. Herewith, for example, when the ink jet printer 50 is left for a long period in the state where the power source is on, it can be detected that whether or not the ink jet printer 50 is left under an environment of a high temperature or the like during the period. Accordingly, when the ink jet printer 50 is used after leaving the ink jet printer 50 for a long period in the state where the power source is on, it can be prevented to execute ink ejection on the recording paper P in the state where the ejection accuracy of ink is deteriorated.

### Second Embodiment of Carriage Control Procedure

FIG. 7 is a flow chart illustrating a second embodiment of the carriage control procedure according to the embodiment.

First, at the moment when the power source of the ink jet printer 50 is turned on, the carriage 62 positioned at the home position HP is moved in the forward direction XL and the dynamic load ZL in the forward direction XL is measured (step S11). Then the carriage 62 is moved in the backward direction XR and the dynamic load ZR in the backward direction XR is measured (step S12). Subsequently, whether the difference of the dynamic load ZL in the forward direction XL and the dynamic load ZR in the backward direction XR is larger or not than a preliminarily set threshold Zd of the difference of dynamic loads is judged (step S13).

As described above, when bending tendency of a bent shape is occurred in the ink tube 11 by leaving the ink jet printer 50 under an environment of a high temperature for a long period or the like, difference of the dynamic load ZL in the forward direction XL and the dynamic load ZR in the backward direction XR is increased than the normal case. Accordingly, whether bending tendency of a bent shape is occurred in the ink tube 11 or not can be judged by whether the difference between the dynamic load ZL in the forward direction XL and the dynamic load ZR in the backward direction XR is larger or not than the preliminarily set threshold Zd of the difference of the dynamic loads.

Note that the threshold Zd can be set to an appropriate value from the relation between the different of dynamic loads in the forward direction XL and the backward direction XR in the normal case by performing an experiment or the like for empirically recreating the state where bending tendency of a bent state is occurred in the ink tube 11 by leaving the ink jet printer 50 under an environment of a high temperature for a long period or the like and for measuring the difference between the dynamic load ZL in the forward direction XL and the dynamic load ZR in the backward direction ZR in the state.

When the difference between the dynamic load ZL in the forward direction XL and the dynamic load ZR in the backward direction XR is not less than the preliminarily set threshold Zd of the difference of the dynamic loads (No in step S13), it is judged that no bending tendency of a bent shape is occurred in the ink tube 11 by leaving under an environment of a high temperature for a long period or the like, and the procedure is finished without change. Then, when the difference between the dynamic load ZL in the forward direction XL and the dynamic load ZR in the backward direction XR is larger than the preliminarily set threshold Zd of the difference of the dynamic loads (Yes in step S13) it is judged that bending tendency of a bent shape is occurred in the ink tube 11 by leaving under an environment of a high temperature for a long period or the like, and a predetermined aging control is executed (step S14), and thereafter the procedure is finished. Note that, the aging control (step S14) in the second embodiment is the similar control as the aging control in the first embodiment (step S3 in FIG. 6), so that the description will be omitted.

### Third Embodiment of Carriage Control Procedure

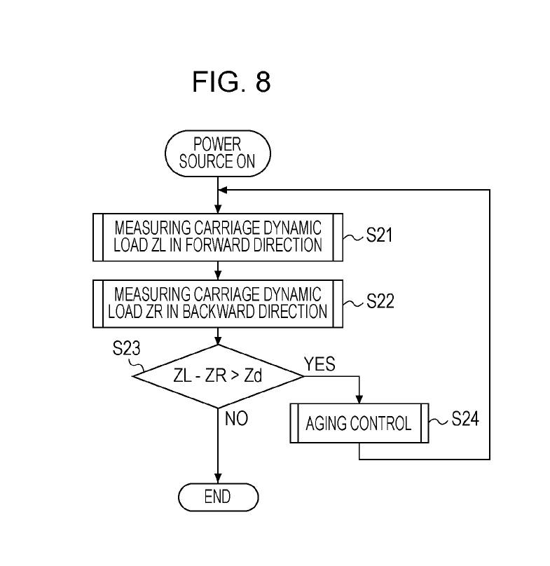

FIG. 8 is a flow chart illustrating a third embodiment of the carriage control procedure according to the invention.

Steps S21 to S24 are the same as the steps S11 to S14 in the second embodiment, so that the detail description for each step is omitted. In the third embodiment, the dynamic load ZL in the forward direction XL and the dynamic load ZR in the backward direction XR are measured (steps S21 and S22). When the difference between the measured dynamic load ZL in the forward direction XL and the measured dynamic load ZR in the backward direction XR is larger than the preliminarily set threshold Zd of the difference of the dynamic loads (Yes in step S23), a predetermined aging control is executed (step S24), and thereafter the procedure is returned to step S21. Then the dynamic load ZL in the forward direction XL and the dynamic load ZR in the backward direction XR are measured again (steps S21 and S22), and whether the difference between the dynamic load ZL in the forward direction XL and the dynamic load ZR in the backward direction XR is larger or not than the preliminarily set threshold Zd of the difference of the dynamic loads is judged again (step S23).

When the difference between the dynamic load ZL in the forward direction XL and the dynamic load ZR in the backward direction XR is not more than the preliminarily set threshold Zd of the difference of the dynamic loads (No in step S23), it is judged that the bending tendency of a bent shape of the ink tube 11 can be corrected by the aging control, and the procedure is finished. On the other hand, when the difference between the dynamic load ZL in the forward direction XL and the dynamic load ZR in the backward direction XR is larger than the preliminarily set threshold Zd of the difference of the dynamic loads (Yes in step S23) it is judged that the bending tendency of a bent shape of the ink tube 11 is not fully corrected by the aging control, and the aging control is executed again (step S24).

In this manner, in the third embodiment of the carriage control procedure according to the invention, whether bending tendency of a bent shape occurred in the ink tube 11 is corrected by the aging control or not can be confirmed (step S23) by measuring the difference of the dynamic loads of the carriage 62 again after the aging control is executed (step S24) in order to correct bending tendency of a bent shape occurred in the ink tube 11. Then, when bending tendency of a bent shape occurred in the ink tube 11 is not fully corrected (Yes in step S23), the aging control is executed again (step S24). Herewith, bending tendency of a bent shape occurred in the ink tube 11 can be further surely corrected.

It should be note here that a control procedure in which the flow char shown in FIG. 6 and the flow chart shown in FIG. 8 are combined may be employed. Herewith, the operation load at the initial stage influenced by the bending tendency can be corrected to an appropriate value, and the difference between the dynamic load ZL in the forward direction XL and the dynamic load ZR in the backward direction XR can be also corrected to an appropriate value. Accordingly, further sure correction of the bending tendency and a high ejection accuracy of ink can be provided. Then, the invention is not limited to the above embodiments, and various modifications can be made in the scope of the invention described in the Claims. It goes without saying that such modifications are also included in the scope of the invention.

What is claimed is:

1. A carriage control device for executing a reciprocal movement control of a carriage in a liquid ejecting apparatus including the carriage that is supported so as to be able to be reciprocally moved in a predetermined direction, the carriage mounting a liquid ejecting head that ejects liquid on a material to be ejected, and a liquid supply tube having thermoplastic property for supplying liquid from a liquid storage unit to the carriage, the liquid supply tube being elastically deformed by following a reciprocal movement of the carriage, wherein
a dynamic load of the carriage is measured at a predetermined timing, and a control for repeating a reciprocal operation of the carriage without ejecting liquid from the liquid ejecting head by a predetermined number of times is executed based on the measured dynamic load.

2. The carriage control device according to claim 1, wherein
when the measured dynamic load is larger than a threshold, the control for repeating a reciprocal operation of the carriage without ejecting liquid from the liquid ejecting head by a predetermined number of times is executed.

3. The carriage control device according to claim 1, wherein
when a difference between the measured dynamic load in a forward direction and the measured dynamic load in a backward direction is lager than a threshold, the control for repeating a reciprocal operation of the carriage without ejecting liquid from the liquid ejecting head by a predetermined number of times is executed.

4. The carriage control device according to claim 1, wherein
a dynamic load of the carriage is measured again after the control for repeating a reciprocal operation of the carriage without ejecting liquid from the liquid ejecting head by a predetermined number of times is executed.

5. The carriage control device according to claim 1, wherein a timing right after a power source of the liquid ejecting apparatus is turned on is included in the predetermined timing.

6. The carriage control device according to claim 1, wherein a timing when not less than a predetermined period is passed in the state where no reciprocal operation of the carriage is executed is included in the predetermined timing.

7. A liquid ejecting apparatus including a carriage that is supported so as to be able to be reciprocally moved in a predetermined direction, the carriage mounting a liquid ejecting head that ejects liquid on a material to be ejected and a liquid supply tube having thermoplastic property for supplying liquid from a liquid storage unit to the carriage, the liquid supply tube being elastically deformed by following a reciprocal movement of the carriage, the liquid ejecting apparatus comprising:
the carriage control device according to claim 1.

8. The liquid ejecting apparatus according to claim 7 further comprising:
a carriage detecting unit capable of detecting a moving amount of the carriage, and
a carriage driving unit for reciprocally moving the carriage, wherein
the carriage control device controls the carriage driving unit based on a detection signal output from the carriage detecting unit.

9. A carriage control program that causes a computer to execute a reciprocal movement control of a carriage in a liquid ejecting apparatus including the carriage that is supported so as to be able to be reciprocally moved in a predetermined direction, the carriage mounting a liquid ejecting head that ejects liquid on a material to be ejected, and a liquid supply tube having thermoplastic property for supplying liquid from a liquid storage unit to the carriage, the liquid supply tube being elastically deformed by following a reciprocal movement of the carriage, the reciprocal movement control comprising:
measuring a dynamic load of the carriage at a predetermined timing; and
repeating a reciprocal operation of the carriage without ejecting liquid from the liquid ejecting head by a predetermined number of times based on the measured dynamic load.
